(19) United States
(12) Patent Application Publication
(10) Pub. No.: US 2004/0129867 A1
(43) Pub. Date: Jul. 8, 2004

(54) Force measurement system using polarization-state modulated optical polarimetry

(76) Inventor: Jeffrey R. Mackey, Concord Township, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/741,702

(22) Filed: Dec. 19, 2003

Related U.S. Application Data
(60) Provisional application No. 60/435,161, filed on Dec. 20, 2002.

(51) Int. Cl. G02F 1/01; G01B 11/16; G01J 1/56

(52) U.S. Cl. 250/225; 250/231.19

(57) ABSTRACT

A compact force measurement system having high sensitivity and a wide dynamic range. A polymer transducer is capable of measuring static, dynamic and transient force changes in tension and compression using changes in optical properties at the molecular level of a pre-stressed polymer or birefringent crystalline material under a loaded condition. A force sensing linkage acts as a load sensor which measures both compression or tension type forces. The transducer is capable of directional force, pressure, and acceleration measurements and is extremely accurate for measuring small-force levels. Since the force transducer of the present invention is based upon optical techniques it is relatively immune to electronic noise and allows measurement of rapidly changing loads. The invention can be miniaturized to accommodate a wide variety of measurements requiring miniature force and/or pressure measurement devices.

This application claims priority to U.S. provisional patent application No. 60/435,161, filed Dec. 20, 2002, the contents of which are hereby incorporated by reference.

### FIELD

This invention relates to a force measurement system using polarization-state modulated optical polarimetry to measure directional force, pressure, and acceleration.

### BACKGROUND

A “transducer” is a device that produces an electrical signal corresponding to the magnitude of a measurable physical property. Transducers are frequently used to measure forces such as tension and compression. The prior art typically measures force using strain gauges, deflection transducers, null-displacement transducers, and piezoceramic transducers.

Strain gauge transducers are typically constructed of metal or semiconductor filaments placed on a backing sheet. The gauge is rigidly attached to a body to be subjected to strain, such as flexible beams or stacked cylinders. Upon deformation of these beams, the strain gauge wire is stretched elastically, which changes the resistance of the wire. By monitoring the resistance, the applied force, or “load” can be determined by referring to transducer-specific calibration curves. Strain gauges are susceptible to electronic noise, making measurement of small forces difficult and subject to inaccuracy. Strain gauges are also subject to errors introduced by temperature variations. Further, a lack of rigidity of the transducer can result in force plate deflections that can exceed 10-20 micrometers, limiting the transducer's resolution and, thus their usefulness, for small-force measurements.

Deflection transducers are similar in function to strain gauge transducers in that the deflection of a beam or a diaphragm is measured by monitoring changes in capacitance or inductance of a device, or by optically measuring the amount of deflection. The deflection versus load characteristic of a deflection transducer is calibrated using known weights. Unfortunately, deflection transducers suffer from the same noise susceptibility and small-force measurement limitations as strain gauges.

A null-displacement transducer is yet another form of transducer. A null-displacement transducer measures forces through optical means or via a linear variable displacement transducer (“LVDT”). The displacement of a rod attached to a load plate is monitored when the plate is subjected to an axial load. A set of coils surrounding the rod effectively act as a solenoid or servo-mechanical system, permitting the application of enough current to move the rod back to its “unloaded” position. The computed load is proportional to the measured drive current. Null-displacement transducers suffer from excessive deflection and a poor response time (typically greater than 1-5 seconds), making them unsuitable for measuring small or rapidly changing forces.

Lastly, there are piezoceramic type transducers that generate an electrical charge corresponding to a load when the crystalline structure of the transducer is distorted by the load. Having a high-impedance measurement system, the charge buildup can be measured and scaled to the load. Piezoceramic transducers have the advantage of requiring little deflection and reasonably good resolution. However, the charge can dissipate over time, making this type of transducer preferably for use with only for transient loads, e.g., cyclical loads.

Recent advances in micro-level research, including micromotion, combinatorial design of drugs, microfluidics, biomimetic adhesive research, and the mechanical response of biological tissue has reinforced an existing need for high sensitivity, robust force transducers capable of measuring both transient and static loads. Commercially available force transducers capable of measuring transient responses generally have a resolution of approximately 10⁻⁵ Newtons, which is insufficient for these areas of research. Although ultra-microbalances exist that have sensitivities well below this range, the averaging techniques employed that allow these measurements make them unsuitable for transient forces, as does the physical size of the systems. There is thus a need for a compact transducer that is capable of measuring small forces with relative immunity to electrical noise. There is a further need for a force transducer having a fast response time that is capable of measuring rapidly changing transient forces. There is a still further need for a force measurement system that is capable of measuring static and dynamic as well as transient loads.

### SUMMARY

According to the present invention, a method is disclosed for a compact, high sensitivity, wide dynamic range force transducer and measurement system capable of measuring static, dynamic, and transient force changes in tension and compression. The operating principle, known as “force sensing linkage,” is based upon measuring the change in optical properties at the molecular level of a pre-stressed polymer material under a loaded condition. The linkage acts as a load sensor which measures both compression and tension forces. The molecular deformation of the linkage is analyzed using miniature optical components arranged as a polarization state modulated polarimeter capable of birefringence measurements on the order of 10⁻⁹. Calibration of the measured birefringence using known loads generates a transducer-specific unique response calibration curve from which measured values for unknown loads may be extrapolated.

The transducer is capable of directional force, pressure, and acceleration measurements and is extremely accurate for measuring small-force levels. Since the force transducer of the present invention is based upon optical techniques it is relatively immune to electronic noise and provides for measurement of rapidly changing loads. The invention can be miniaturized to accommodate a wide variety of measurements requiring miniature force and/or pressure measurement devices such as medical devices. Examples of some potential uses for medical transducers include, without limitation, inter-cranial pressure lines, diabetic foot stress sensor arrays, and inner ear pressure sensors used for the diagnosis and treatment of Meniere's disease.

One object of the present invention is a birefringent linkage transducer for measuring force comprising a polymer having generally uniaxially oriented polymer chains. In one embodiment of the present invention, the polymer is polystyrene.

Another object of the present invention is a system for measuring force applied to a transducer, comprising: a source of coherent light having an output; a linear polarizer optically coupled to the output of coherent light, effective to polarize the coherent light passing therethrough; a variable retarder optically coupled to the polarized light; a polarization state modulator optically coupled to the variable retarder to periodically vary the phase of the polarized light passing through the variable retarder; a birefringent linkage transducer having generally uniaxially oriented polymer chains, the transducer being optically coupled to the phase-modulated, polarized light effective to generate a stress information optical signal when the phase-modulated, polarized light passes through the transducer; a linear analyzer optically coupled to the optical signal to polarize the stress information optical signal; a photodetector coupled to the polarized optical signal to derive stress tensors for the transducer, wherein the stress tensor data corresponds to the amount of force applied to the transducer.

Yet another object of the invention is a system for measuring force applied to a transducer, comprising: a source of coherent light having an output; a first collimator optically coupled to the output, effective to concentrate the light into a beam of coherent light; a first linear polarizer optically coupled to the beam of coherent light, effective to polarize the beam; a polarization state modulator optically coupled to the first linear polarizer to periodically vary the phase of the beam of polarized, coherent light emitted from the first linear polarizer; a beam splitter optically coupled to the polarization state modulator to split the phase modulated beam of light into first and second phase modulated sub-beams; a second collimator optically coupled to the first phase modulated sub-beam; a third collimator optically coupled to the second phase modulated sub-beam; a birefringent linkage transducer having generally uniaxially oriented polymer chains, the transducer being optically coupled to the second and third collimators such that the first and second phase modulated sub-beams pass through the transducer generally orthogonally and intersect within the linkage, interaction at the intersection of the first and second sub-beams generating first and second stress information optical signals containing phase information from which the force applied to the linkage can be derived; a first linear analyzer optically coupled to the first stress information optical signal to linearly polarize the first stress information optical signal; a second linear analyzer optically coupled to the second stress information optical signal to linearly polarize the second stress information optical signal; an optical multiplexer optically coupled to the first and second stress information optical signals to combine the first and second stress information optical signals into a multiplexed stress information optical signal; a photodetector optically coupled to the optical multiplexer to decode the multiplexed optical stress information signal into a corresponding electrical signal; and a signal recovery processor electrically coupled to the photodetector effective to derive phase retardance and molecular orientation angle and derive stress tensors for the transducer, the stress tensors corresponding to the amount of force applied to the transducer.

Still another object of the present invention is a system for measuring force applied to a transducer, comprising: a source of coherent light having an output; a polarizer optically coupled to the output of coherent light to polarize the coherent light passing therethrough; a variable retarder optically coupled to the polarizer to vary the optical orientation of the light; a modulator electrically coupled to the variable retarder to modulate the light by periodically varying the orientation of the retarder with respect to the light; a beam splitter to split the light into a first light sub-beam and a second light sub-beam; a birefringent polymer linkage transducer having a generally uniaxially oriented polymer chains, the linkage being arranged such that the first light sub-beam and second light sub-beam are optically coupled to the linkage generally orthogonally and intersect within the linkage; first and second optical signals output from the linkage transducer, the first and second optical signals resulting from interaction at the intersection of the first and second sub-beams within the linkage transducer, each optical signal containing phase information from which the force applied to the linkage can be derived; a first linear analyzer optically coupled to the first optical signal to polarize the first optical signal; a second linear analyzer optically coupled to the second optical signal to polarize the second optical signal; a first photodetector optically coupled to the first linear analyzer to derive the force information from the first optical signal; a second photodetector optically coupled to the second linear analyzer to derive the force information from the second optical signal; and a recovery processor electrically coupled to the first and second photodetectors effective to derive optical phase retardance and molecular orientation information of the transducer in three dimensions, wherein individual stress tensors in three dimensions are derived from the optical phase retardance and molecular orientation information, the stress tensors relating to the force exerted upon the transducer.

Yet another object of the present invention is a method for using a birefringent transducer for measuring applied force, comprising the steps of: generating a beam of coherent light; polarizing the beam of coherent light with a linear polarizer; modulating the phase of the polarized beam of light with a variable retarder; passing the modulated beam of light through a birefringent transducer, the birefringent transducer having generally uniaxially oriented polymer chains effective to generate a stress information optical signal; passing the stress information optical signal through a linear analyzer to polarize the optical signal; and deriving stress tensors for the transducer from the polarized optical signal, wherein the stress tensor data corresponds to the amount of force applied to the transducer.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1A shows a relaxed polymer chain;

FIG. 1B shows an oriented polymer chain;

FIG. 2A depicts the general arrangement of an extensional flow process;

FIG. 2B depicts the process of FIG. 2A wherein a polymer is stretched to orient its polymer chains;

FIG. 3 illustrates the general arrangement of a channel die;

FIG. 4A is a simplified side elevational diagram of a channel die and a polystyrene section;

FIG. 4B shows a representative polymer chain for the section of FIG. 4A;

FIG. 4C illustrates the polystyrene section of FIG. 4A after a compression cycle;

FIG. 4D shows a representative polymer chain for the section of FIG. 4C;

FIG. 4E show a simplified side elevational diagram of a channel die and a polystyrene section that has been divided into portions and stacked;

FIG. 4F shows a representative polymer chain for the sections of FIG. 4E;

FIG. 4G shows a simplified side elevational diagram of the arrangement of FIG. 4E following a compression cycle;

FIG. 4H shows a representative polymer chain for the molded polystyrene of FIG. 4G;

FIG. 5 depicts a schematic diagram of the general arrangement of a liquid crystal modulator birefringence measurement system according to an embodiment of the present invention;

FIG. 6 shows the orientation axes of a liquid crystal modulator system;

FIG. 7 illustrates the response of a liquid crystal variable retarder to a sawtooth electrical waveform;

FIG. 8 illustrates the response of a liquid crystal variable retarder to a triangular electrical waveform;

FIG. 9 illustrates the response of a liquid crystal variable retarder to a sinusoidal electrical waveform;

FIG. 10 depicts normalized plots of Bessel functions;

FIG. 11 depicts a normalized plot of a frequency-doubled first harmonic fitted to the J,(A) Bessel function;

FIG. 12 is a graph of optical phase retardance and orientation angle in radians of a quarter wave plate;

FIG. 13 is a graph of optical phase retardance and orientation angle of a quartz crystal;

FIG. 14 illustrates a general arrangement of a polarization-maintaining fiber-coupled LCVR modulated transducer input section according to an embodiment of the present invention;

FIG. 15 illustrates the general arrangement of a mirrored force transducer measurement system according to an embodiment of the present invention;

FIG. 16 illustrates the general arrangement of an electro-optic modulator according to an embodiment of the present invention;

FIG. 17 illustrates an oscillocope measurement of an LCVR drive signal and a detector output, used to check alignment;

FIG. 18 is a block diagram of a force measurement system according to an embodiment of the present invention;

FIG. 19 is a block diagram of an example signal recovery and modulator drive circuit according to an embodiment of the present invention;

FIG. 20 is a block diagram of an open path force measurement system according to an embodiment of the present invention;

FIG. 21A is a diagram illustrating forces applied to a polymer linkage;

FIG. 21B is a diagram showing the computation of force applied to a polymer linkage

FIG. 22 is a view of the typical forces present on the sole of a foot;

FIG. 23 is a schematic top plan view of a sensor array according to an embodiment of the present invention; and

FIG. 24 depicts an integrated modulated diode laser package according to an embodiment of the present invention.

### DETAILED DESCRIPTION

1. Overview of Birefringence

Birefringence (termed Δn′) is defined as the anisotropy in a material's refractive index with respect to the polarization state of light propagating through it. In an optically transparent polymer material under stress, the orientation and degree of deformation of the polymer molecules cause an anisotropic polarization. If a light propagates along the z-direction through a birefringent material, the x and y components of its electrical field vector will be different from one another. This results in a phase difference or retardance (termed δ) as the light traverses the birefringent material. If the material is not dichroic, then the retardance is related directly to its birefringence. This can be expressed by Equation 1:

$$Δ {n}^{′} = {n}_{0} - {n}_{e} = - \frac{δ λ}{2 π d} \qquad Equation 1$$

where nₒ and nₑ are the refractive indices for ordinary and extraordinary light rays respectively, λ is the wavelength of the light in a vacuum and d is the sample-material thickness. This can be applied through the use of the stress-optical law which provides a simple relationship between the material stress and the refractive-index tensor. In terms of the stress components, the stress-optical law can be expressed by Equations 2 and 3:

$${τ}_{x y} = \frac{1}{2 C} Δ {n}^{′} sin ( 2 χ ) \qquad Equation 2$$

$${τ}_{x x} - {τ}_{y y} = \frac{1}{C} Δ {n}^{′} cos ( 2 χ ) \qquad Equation 3$$

where τ_{xy} is the shear stress, τₓₓ−τ_{yy} is the first normal stress difference, C is the birefringent material's stress-optical coefficient and χ is the instantaneous orientation angle of the molecular polymer chains with respect to the flow direction. Thus, in order to unambiguously ascertain a material's state of stress, the birefringence and orientation angle must be measured simultaneously.

In order to compute an applied stress or force acting upon a polymer linkage, the path length dependence must be known. The applied stress (or force) is a function of birefringence, molecular orientation angle and stress optical coefficient. The birefringence depends upon optical phase retardation, which is also a function of the optical path length as shown in Equation 4:

$$δ = \frac{2 n d}{λ} Δ {n}^{′} \qquad Equation 4$$

Where δ is the optical phase retardance, d is the optical pathlength through the sample material, λ is the wavelength of light and Δn′ is the material birefringence.

Path length dependence with no stress applied to the linkage is linear. The dependence of the optical phase retardance on optical path length will also vary in accordance with the amount of applied stress. This relationship will become nonlinear near the yield point of the polymer linkage material.

2. Birefringent Transducer Construction

Oriented polymer “linkages” or transducers are preferred for use in birefringence measurements. Any conventional birefringent material known in the art having a generally uniaxially orient polymer chain may be used. Polystyrene is favored because it has a high degree of birefringence, measured as the refractive index difference normal and parallel to the main chain of the polymer. In addition, polystyrene has a high modulus and yield stress, resulting in a stiff linkage with little permanent plastic deformation until high stresses are reached. Lastly, polystyrene, being a common thermoplastic, is both relatively easy to process and to obtain in raw form. Raw polystyrene in extruded pellet form is preferred over powder, as transducers molded from powder are prone to bubble entrainment which can hamper transducer function due to distortion of optical signals that pass through the transducer.

A birefringent transducer preferably has a high degree of permanent polymer orientation. Orientation in polymers can be obtained by subjecting the polymer to specific flow fields which stretch out the polymer chains while in a molten phase (i.e. when the polymer is above its glass transition or melting temperature), then quenching the sample prior to relaxation of the polymer chains. Polystyrene has a glass transition temperature of about 100° C.

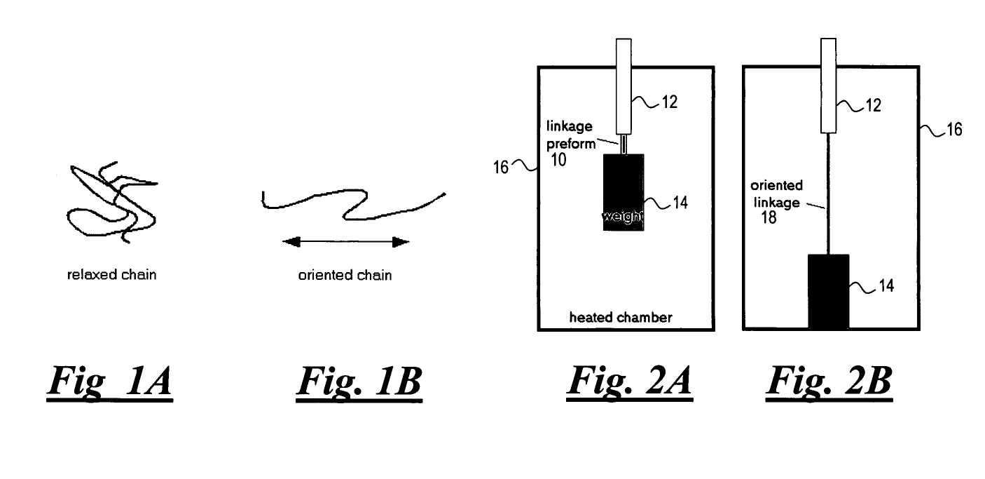

An example of a polymer chain before and after the application of an orienting flow is shown diagrammatically in FIGS. 1A and 1B respectively. The randomly-oriented polymer chain of FIG. 1A would show no net birefringence when used as a transducer, while the chain of FIG. 2B has been subjected to an orienting flow as indicated with the arrows, and would show a high degree of orientation.

Transducers having uniaxially oriented polymer chains may be obtained via extensional and channel die flow processes which further orient the polymer chains. An extensional flow process is illustrated in FIGS. 2A and 2B. A “linkage preform” or blank for a transducer comprising a sample of polystyrene 10, such as a cylindrical section, is connected to an upper restraint 12 and a weight 14. This arrangement is then heated to a temperature of about 175° C. by use of a conventional environmental chamber or oven 16. As the polystyrene section 10 is heated, it is stretched by weight 14, causing the formation of a generally aligned filament 18 having an oriented chain linkage as shown in FIG. 1B. Filament 18 is subsequently usable as a transducer, as will be discussed in greater detail below.

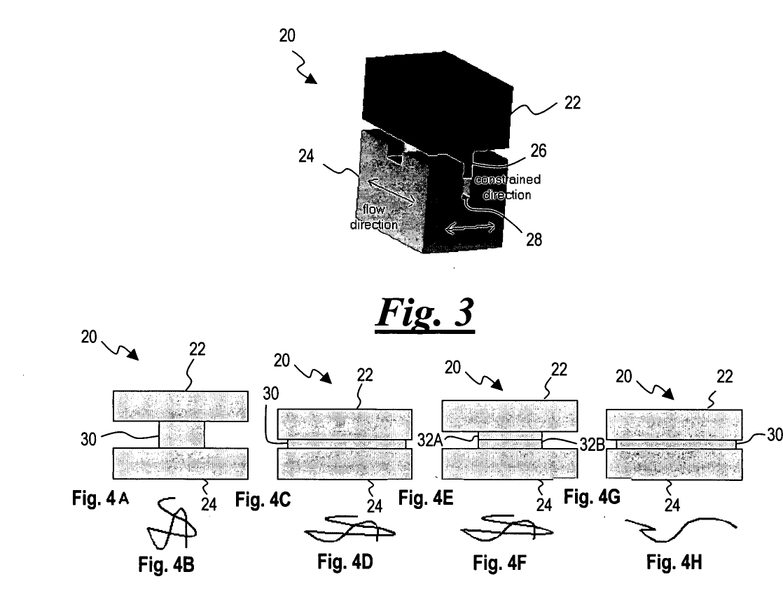

Channel dies may also be used to prepare transducers having oriented-chain linkages. A channel die generates a constrained planar flow field for a polymer while in its molten phase, allowing generally uniaxial orientation of a polymer. An example channel die 20, comprising an upper die 22 and a lower die 24, is shown in FIG. 3. Upper die 22 comprises a tongue 26, which detachably mechanically couples to a channel 28 of lower die 24.

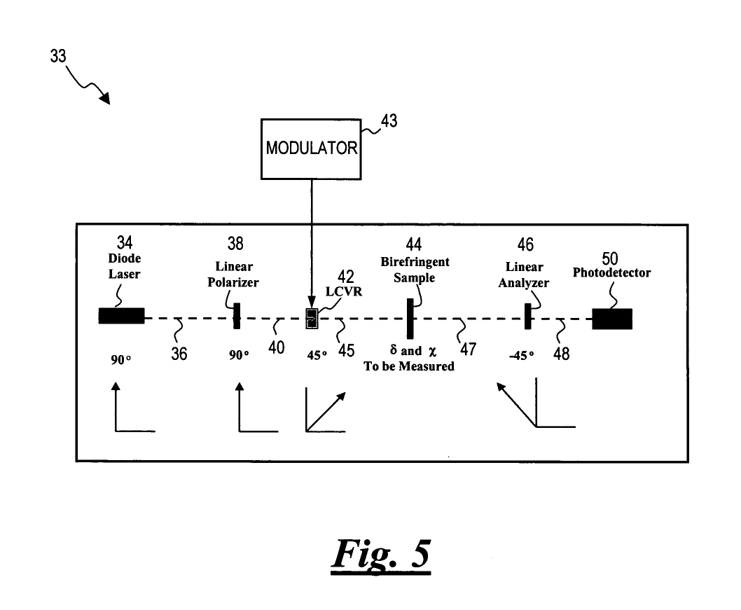

Polystyrene pellets (not shown) are preferably first molded into relatively thin sheets, sectioned into generally rectangular strips, then placed into channel 28 of die 20 and compression molded in a conventional platen press (not shown) at a temperature of about 175° C. such that the molten polystyrene flows within the confined space defined by tongue 26 and channel 28 as upper die 22 is pressed into lower die 24 by the platen press. After the upper and lower dies 22, 24 are heated and compressed completely together, die 20 is quickly removed from the platen press and quenched in a liquid such as water, which is maintained at a temperature below the glass transition temperature of the polystyrene to minimize relaxation of the polymer chains. To generate higher degrees of orientation, linkages may be formed in channel die 20 as shown in FIGS. 4A and 4C, removed, sectioned into portions 32A, 32B (see FIG. 4E), stacked atop each other in channel 28 as shown in FIG. 4E, and then re-molded as shown in FIG. 4G. Channel die 20 preferably produces transducer linkages in the range of about 2 mm in width and 30 mm in length. The linkage thicknesses in the beam direction are preferably between about 0.5 mm and 2 mm.

After one compression cycle (i.e., FIG. 4A and FIG. 4C) the polymer chains are more closely aligned, as shown schematically in before-and-after FIGS. 4B and 4D respectively. When the linkage 30 is divided into portions 32A and 32B, stacked, and pressed again, the partially-aligned chains are further aligned in the second compression (see FIG. 4F and FIG. 4H). This process can be continued for multiple compressions to attain a large degree of strain without requiring a long channel die 20 with an unduly long channel 28, which in turn would require a molding press with correspondingly large platens.

To determine the bulk degree of chain orientation, the linkages may be annealed above their glass transition temperature until they have relaxed to a steady-state length. The residual orientation, or strain ε, is computed from the change in length L normalized by the initial length L₀, as indicated by Equation 5:

$$ϵ = \frac{Δ L}{{L}_{0}} \qquad Equation 5$$

The amount of relaxation is proportional to the uniformity of orientation of chain linkages.

3. Light Modulating Optical Trains

A. Liquid Crystal Polarization Modulator

Prior art systems for birefringence measurement (termed “electro-mechanical modulators” herein) typically use a dual crystal electro-optic modulator, a conventional Pockels cell, a photo-elastic modulator or a simpler system wherein an optical retardation plate is rotated with a mechanical motorized system. Although the mechanical rotation system can accommodate large aperture sizes the rotation speed is limited due to the mechanical moving parts, limiting the sensitivity of the measurement system. Further, the necessarily large physical size of the components of an electro-mechanical birefringence measurement system do not permit construction of a compact device. A liquid crystal modulator has several advantages over electro-mechanical modulators including smaller size, lower cost, a much larger aperture for ease of alignment, and the potential for two-dimensional birefringence measurement. Liquid crystal retarders are essentially optically anisotropic media that act locally as a uniaxial retardation plate and exhibit optical birefringence. Generating an E-field across the liquid crystal media produces different polarization states for the media, depending on the applied voltage. Thus, a time-varying E-field may be employed as polarization modulator.

Accurate, stable measurements of birefringence call for non-intrusive, compact instruments that modulate the polarization of light. As previously noted, prior systems for measuring birefringence use an electro-mechanical modulator. A significant drawback of using an electro-mechanical modulator is a need to closely align the instrument, since the modulator typically has only about a 4 mm diameter aperture through which the light beam must pass. Thus, a slight misalignment may compromise the accuracy of the retardance and birefringence measurement. An advantage of using a liquid crystal modulator according to an embodiment of the present invention is an inherently larger diameter aperture that allows easy, consistent alignment, aiding the accuracy of the instrument. Thus, the liquid crystal modulator allows greater ease of use without compromising its accuracy.

B. Liquid Crystal Modulation Characteristics

A conventional liquid crystal variable retarder comprises a plurality of liquid crystals placed between a pair of optically transparent or translucent elements or grids. Liquid crystals are usually in a liquid state, but they also exhibit properties of a solid crystal. When the crystals are exposed to an external electrical field applied between the elements the orientation of the crystals will change. This property can be used to control the phase of light passing through the liquid crystals.

Nematic liquid crystals are optically equivalent to a linear waveplate whose optical axis is fixed, but whose birefringence is a function of the voltage applied to the grids. As the applied voltage increases above 0 volts the birefringence changes from typically about 0.2 nm/cm to near zero. The resulting change is the optical path length for a linearly polarized light propagating parallel to the extraordinary axis, (Δn′)d, where d is the thickness of the film and Δn′ the change in birefringence. Factors influencing the birefringence of liquid crystals for a given voltage include the type of liquid crystal materials, spacing between grids (“thickness”), and temperature.

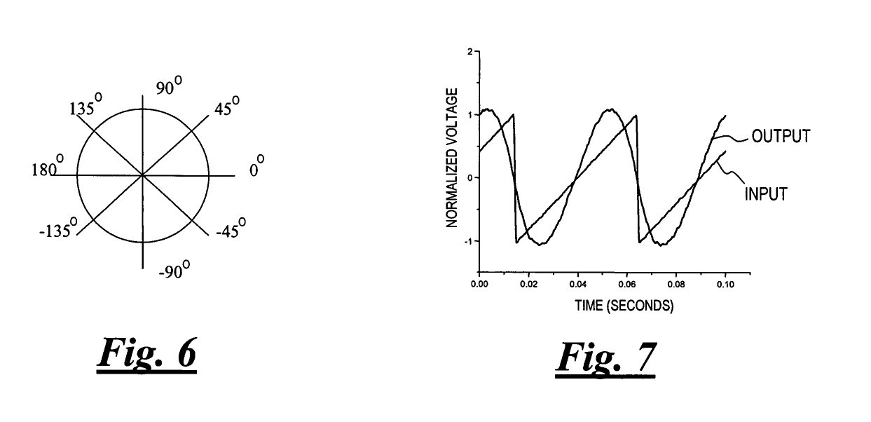

Liquid crystal variable retarders (“LCVRs”) are tunable waveplates that, in conjunction with linear polarizers, form the circular and oriented linear polarizers that are required to characterize the polarization of an unknown light beam in a Stokes Polarimeter. The response time of an LCVR depends on several factors, such as the liquid crystal layer thickness, viscosity, temperature and surface treatment as well as the driving electrical waveform. The response time is also sensitive to the direction of the retardance change as well as the absolute value of the liquid crystal retardance. In general, the response time of an LCVR is much faster when using a higher electric field potential. The electric field applies an external “torque” to each liquid crystal molecule, but when the field is removed or switched to a lower value, interactions between liquid crystal molecules provide the dominant forces. These interactive forces are much weaker than the torque caused by an external electrical field, leading to a slower relaxation time. In many applications it is only necessary to quickly switch in one direction, such as with a sawtooth wave as shown in FIG. 7.

FIG. 5 shows a schematic diagram of the general arrangement of a liquid crystal modulator birefringence measurement system 33 according to an embodiment of the present invention. A diode laser 34 generates a collimated beam of light 36. Light beam 36 is optically coupled to a linear polarizer 38, which allows only light components that are parallel to a predetermined polarizing axis to pass. The polarized light 40 is optically coupled to a liquid crystal variable retarder 42 which is in turn modulated by a modulator 43 that applies variable voltages to the grids (not shown) of the LCVR. The modulated light beam 45 is then passed through a birefringent transducer 44. Birefringent transducer 44 is a polystyrene link produced in the manner previously discussed. The resultant optical signal 47 is then optically coupled to a linear analyzer 46. Linear analyzer 46 linearly polarizes the light beam 40, resulting in polarized light beam 48. Linear analyzer 48 may be similar to polarizer 38, but oriented in different rotations with respect to the incident light. Polarized light beam 48 is optically coupled to a photodetector 50, which receives the light beam and analyzes it using conventional offset homodyne signal recovery to derive stress tensors for transducer 44 resulting from forces applied to the transducer. The stress tensor data is used to measure and quantify the forces.

Liquid crystal birefringence measurement system 33 employs conventional Stokes parameters and Mueller Matrix representation of each optical element in the system. In the discussion that follows the characterization of the liquid crystal modulator is discussed first, followed by the physics of the liquid crystals based upon the Nematic Transient Effects, which change the liquid crystal nematic structure birefringence as a function of the voltage applied.

Different types of voltage modulation of LCVR 42 by a modulator 43 will result in different types of polarization modulation of the LCVR. The polarization modulation can be observed by placing a polarizer at 90 degrees (i.e., vertical), LCVR 42 at −45 degrees, an analyzer at −45 degrees to filter out the polarization at one angle, and a photodetector to view the polarization modulation at the angle of the analyzer. Modulating the input voltage applied to LCVR 42 will change the polarization states of light between 0 degrees and 180 degrees. FIG. 6 shows the orientation axes.

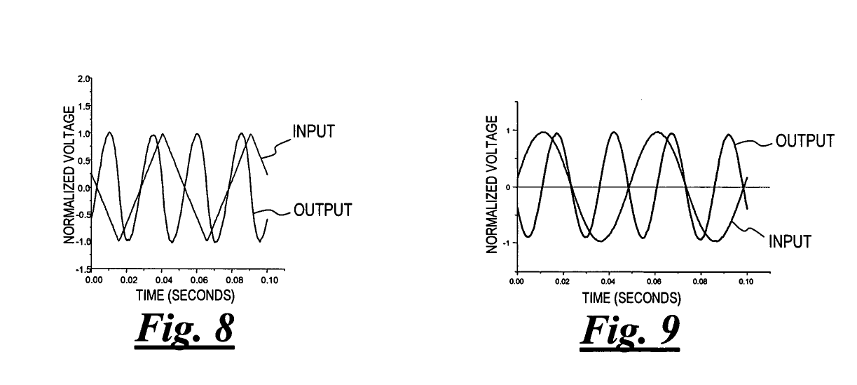

With reference to FIG. 7 in combination with FIG. 5, a saw-tooth wave voltage input to LCVR 42 by modulator 43 will result in modulating the polarization of the modulated light beam 45 to the same frequency as the input. However, a triangular-wave voltage input to LCVR 42 by modulator 43 will result in a polarization modulation output 45 having twice the frequency of the input, as shown in FIG. 8. A sinusoidal modulation input voltage will also result in a polarization modulation output 45 having twice the frequency of the input, as shown in FIG. 9. One skilled in the art will recognize that the liquid crystals of LCVR 42 respond to the transient change in the director field voltage in either polarity and relax back to the original state when there is no electric field (i.e., zero voltage) applied to the LCVR. The relaxation period of the directors is typically relatively slow. Thus, modulation of nematic liquid crystal based retarders is limited to less than about 1 kHz. Ferroelectric liquid crystals may be used for modulation at higher rates. Due to the structured layer forms of the ferroelectric liquid crystals they are generally bistable. Thus, if a DC field is applied with certain polarity the optical axis points in a given direction, and when the field is reversed the optical axis switches to an approximate angle of 45 degrees. This switching of optical axis produces a polarization state modulation necessary for signal analysis.

Liquid crystal modulator 43 has the property of modulating the polarization of light through one complete cycle each time the voltage input is increased or decreased. The liquid crystals go through one cycle of polarization when the input voltage is ramping up. As shown in FIGS. 8 and 9, the liquid crystals go through one cycle of polarization (one cycle occurs when the electric field vector is rotated by one complete revolution) when the modulating input voltage is ramping upward and another cycle when the voltage is ramping downward.

C. Calculation of Retardance and Orientation Angle

The optical phase retardance must be computed prior to making any force measurements. The molecular orientation angle of the polymer linkage material must be computed if additional shear stress measurements or complete three-dimensional stresses are to be made. These quantities are directly related to force, pressure and stress measurements through equations 2 and 3.

From the input Stokes vector of the linearly polarized light and the Mueller matrices of all the sequences of the optical elements, the Glann Thompson polarizer, the liquid crystal retarder, sample material, the cross polarizer (i.e., the second Glann Thompson polarizer), the intensity results of the second and fourth harmonics are related to the first and second orders of the Bessel functions and a stress tensor M. The modulated output intensities at the second harmonic and the fourth harmonics are given by Equations 6 and 7:

I_{2ω}=2I_{dc}J₁(A₀)M₃₄ Equation 6

I_{4ω}=2I_{dc}J₂(A₀)M₃₂ Equation 7

The results of the derivation of Mueller matrices showing that, as the sinusoidal input voltage, A is increased, the second harmonic, I_{2ω} follows the same curve as the first order Bessel function, J₁(A), and also the fourth harmonic, I_{4ω} has the same shape as the second order Bessel function, J₂(A). From these results both the retardance and the orientation angle can be simultaneously calculated at any sampling time using Equations 2 and 3. The following variables may be defined:

$$\begin{matrix}{R}_{2 ω} = \frac{{I}_{2 ω}}{2 {I}_{d c} {J}_{1} ( {A}_{0} )} & Variable 1 \\ {R}_{4 ω} = \frac{{I}_{4 ω}}{2 {I}_{d c} {J}_{2} ( {A}_{0} )} & Variable 2\end{matrix}$$

M=1−R_{2ω}²−R_{4ω}² Variable 3

These variables are used to obtain the instantaneous measurements for retardance, δ, and the orientation angle, χ.

D. Liquid Crystal Modulator Calibration

Liquid crystal modulator calibration must be performed if a liquid crystal variable retarder (LCVR) is used as a polarization state modulator. The calibration point (i.e., the point at which the LCVR drive voltage is set) must be known in order to determine variables 1-3, discussed above.

To greatly simplify the analysis and calculation of birefringence, the zero order Bessel function, J₀(A) is set to zero in order to arrive at variables 1-3. At the point J₀(A)=0, the first-order Bessel function will be, J₁(A)=0.5191 and the second-order Bessel function will be, J₂(A)=0.4317. The theoretical plots for J₀(A), J₁(A), and J₂(A) are shown in FIG. 10, where A is the input voltage. The values of these Bessel functions are well-known in the art. It is useful to set the modulator voltage to a constant so that these values do not change. A change in these values will cause a calibration shift and thus invalidate measurement results.

One method of calibrating the liquid crystal modulator is achieved by using the general arrangement of FIG. 5 and measuring the 2^{nd} harmonic I_{2ω} and the 4^{th} harmonic I_{4ω} using two “lock-in amplifiers” (not shown). Lock-in amplifiers are used to measure the amplitude and phase of signals having a significant noise component. Lock-in amplifiers as a portion of photodetector 50 as a narrow bandpass filter which removes much of the unwanted noise while allowing through the signal which is to be measured. The frequency of the signal to be measured and hence the passband region of the filter is set by a reference signal, which has to be supplied to the lock-in amplifier along with the unknown signal. The reference signal must be at the same frequency as the modulation of the signal to be measured.

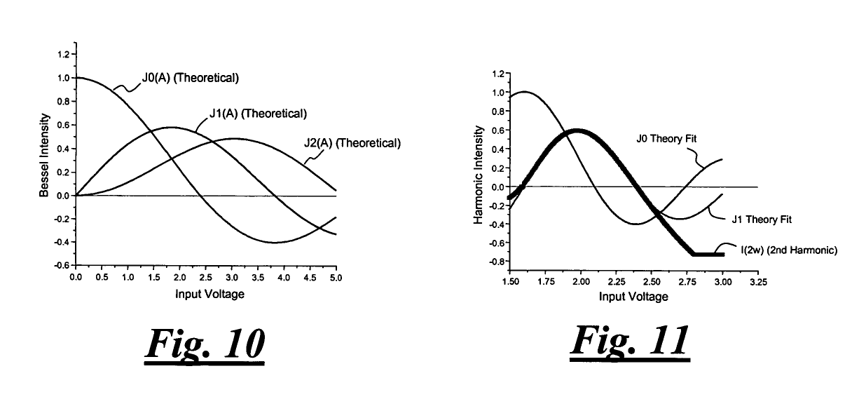

With continued reference to FIG. 5, a light beam emitted from a collimated laser diode 34 is passed through a vertical 90 degree polarizer 38 to eliminate all states of polarization, except for the vertical plane polarized-state. Then, the beam passes through LCVR 42 with its slow axis (the direction perpendicular to the optic axis in a negative uniaxial retarder) oriented at −45 degrees. A modulator 43 that increments the input voltage is used to drive LCVR 42. Next, the light beam passes through a birefringent sample 44 with time varying retardance and orientation angle. The laser beam passes through the analyzer 46 to detect the maximum intensity of modulation, which occurs at the −45 degree state of polarization. This will allow the detection of second and fourth harmonics, which may be measured simultaneously by the two lock-in amplifiers (not shown) in conjunction with photodetector 50. The normalized plot for the frequency-doubled first harmonic fitted to the J₁(A) Bessel function is shown in FIG. 11.

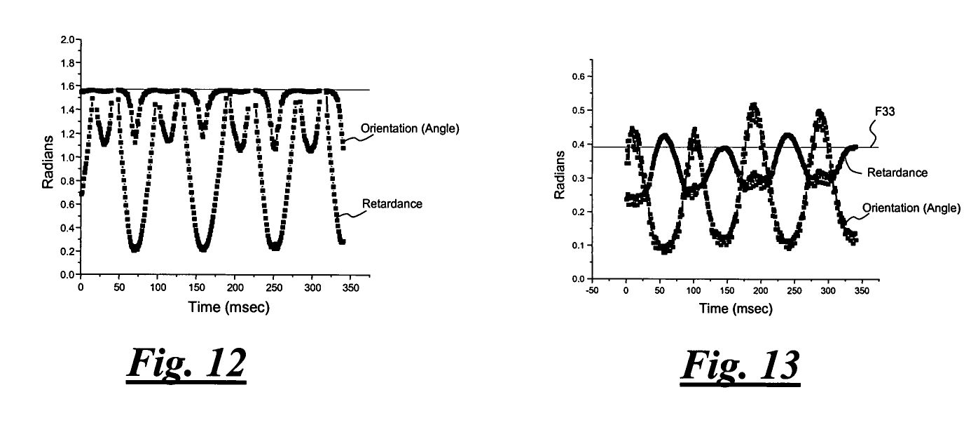

An LCVR 42 according to an embodiment of the present invention has a typical operating voltage between about 1.5 to 2.5 Volts RMS. The point at which J₀(A)=0 is approximately 2.0933 Volts RMS. Calibrating for the second harmonic is sufficient to determine the calibrated sinusoidal input voltage and allow the calculation for the retardance and birefringence. FIG. 12 shows that the retardance and orientation angle fluctuate between about 0 to about 1.5708 radians. The averaged relative peak of the retardance shown in FIG. 12 was calculated experimentally at 1.514 radians. This matches the expected value of 1.5708 radians with a less than 5 percent error, which is well within the percent uncertainty of a conventional wave plate.

The sample quarter waveplate may be replaced with a sixteenth waveplate made of quartz and the same calculations made. The sixteenth waveplate has the retardance illustrated in Equation 8:

$$of δ = \frac{π}{8} = 0.392 radians \qquad Equation 8$$

The result is a calibration check using a sample of known birefringence. FIG. 13 shows the retardance and orientation angle of the quartz crystal.

The average maximum experimental retardance measurement according to an embodiment of the present invention is 0.4172 radians. This corresponds to a 6.43 percent error. With the plot of retardance and orientation angle, the birefringence may be calculated using Equation 4. If the thickness of the quartz is about 1.97 mm, a zero-order birefringence measurement of Δn′=2.3077·10⁻⁵ will be achieved.

Knowing the stress-optical coefficient from tabulated values well-known in the art, or by calculating it through polarimetric measurement, the stress tensors may be calculated by using equations 1 and 2. This method can be used to measure the retardance and orientation angle of an unknown sample and then calculate the birefringence and stress of the material. Many different types of optical materials can be applied, including polymers, plastics, fluids and lenses.

E. Polarization-Maintaining Fiber-Coupled LCVR

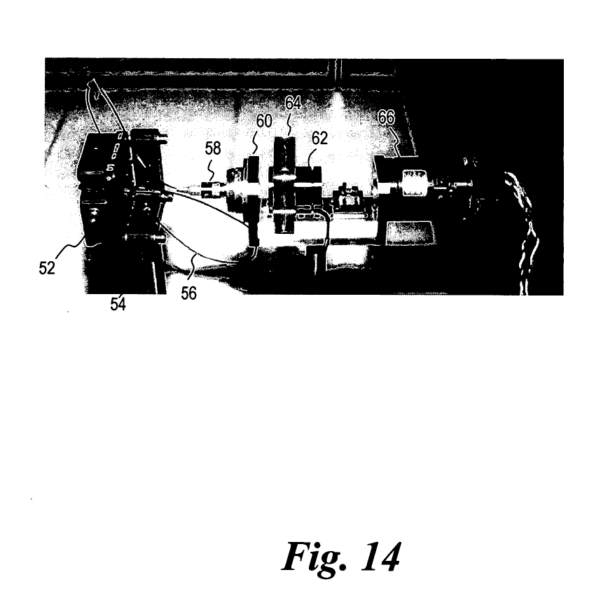

Coupling of the modulated laser beam to a polarization-maintaining (“PM”) optical fiber and observing modulation depth is now considered. The general arrangement of the input section of a fiber-optic coupled LCVR is shown in FIG. 14 and comprises a fiber collimator mount 52, a fiber collimating lens 54, a PM fiber 56, a fiber coupler 58, a fiber mount 60, an LCVR 62, a linear polarizer 64, and a diode laser 66. An output section comprises a linear analyzer 46 and a high-speed photodetector 50 (see FIG. 5). A loss of modulation amplitude observed through the analyzer prior to and after coupling will indicate an alteration of polarization state. Such a change in polarization state will reduce the sensitivity of the force measurement. Experience has shown that there is no observable loss of modulation amplitude with respect to the DC output when the modulated laser beam is optically coupled into the PM fiber. Therefore, measurement sensitivity is not noticeably compromised by PM-fiber coupling, which allows multiple force transducers to be powered by a single laser, polarizer and modulator.

F. Two-Axis Force Testing

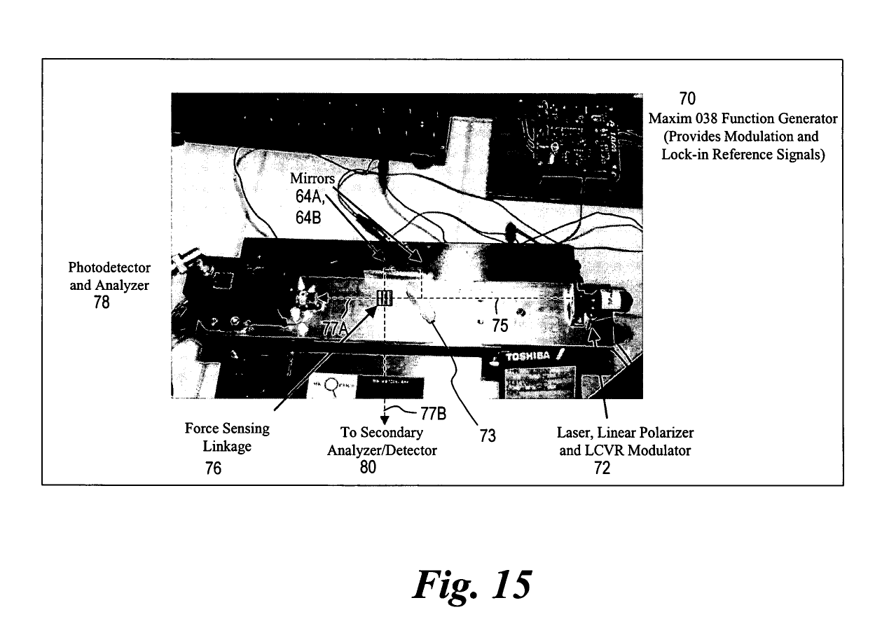

To facilitate measurement of two stress axes simultaneously, two small mirrors and a approximately 50/50 beam splitter 73 may be assembled as shown in FIG. 15. Any conventional beam splitter known in the art may be used, including but not limited to fiber optic splitters, variable density beam splitters, polarizing cube beam splitters, stepped-density beam splitters, prisms, pellicle beam splitters, plate beam splitters, dielectric beam splitters and mirrored splitters. A function generator 70 provides modulation and reference signals for lock-in amplifiers (not shown). A first assembly 72 comprises a laser, a linear polarizer, and an LCVR, which function as discussed above. A pair of mirrors 74A, 74B are arranged to split a beam 75 into two sub-beams 77A and 77B. Birefringent linkages 76 are placed in the region where the split beams 77A, 77B cross and their residual stress birefringence is measured by a first analyzer/detector 78. Since the reflected beam undergoes an odd number of reflections (i.e., three reflections), each having a 180 polarization state shift, the output beam supplied to the secondary analyzer/detector system 80 should have the same modulation characteristics as the transmitted beam. Examination of the detector signals from both beams indicates no appreciable degradation in modulated beam characteristics. Force measurements are obtained by equations 1 and 2. The mathematical computations must be performed in the two orthogonal axes governed by the instrument geometry. The molecular orientation angle, χ may be different from one axis to the other.

G. Electro-Optic Modulator

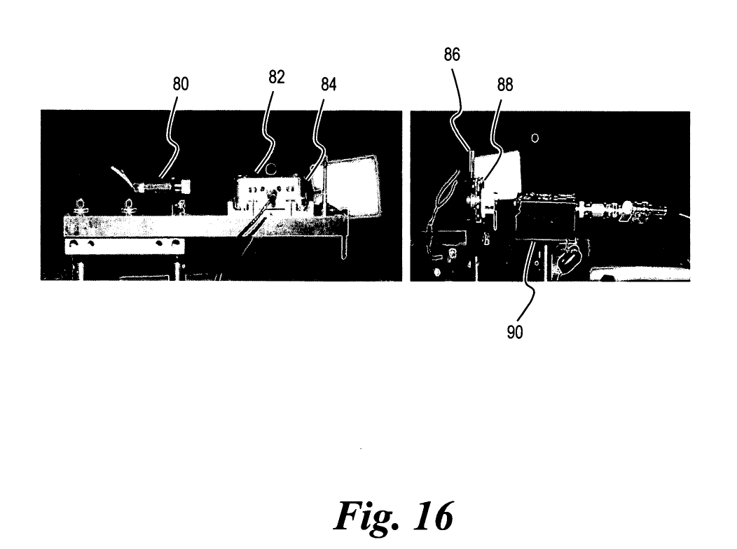

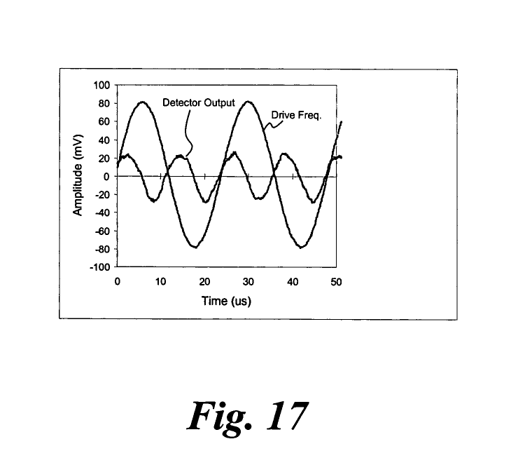

An electro-optic modulator subsystem is shown in FIG. 16 and comprises a diode laser 81, a collimating lens and housing 82, a linear polarizer 84, a polarization state modulator 86, a polystyrene test linkage 88, and a rotary mounted linear analyzer and photodetector 90. For alignment purposes, the analyzer/detector 90 is rotated to 90 with respect to the linear polarizer 84, creating a crossed polarizer configuration. This configuration will produce only a second harmonic from the photodetector with no birefringent sample between the modulator and the analyzer. To check alignment, a conventional oscilloscope trace may be observed. An example trace is plotted in FIG. 17. Since the system is now modulating polarization state from zero to a calibrated predetermined finite value, the troughs of the signal will be near or at the same value when the laser beam is blocked and no light is incident upon the detector. In addition, if the system is aligned correctly, the signal peaks will all have the same height. Any deviation from these conditions indicates a need to realign the optical elements in accordance with the mathematical model derived from the Mueller matrices.

4. Force-Measurement Systems

A. Closed-Path Force Measurement System

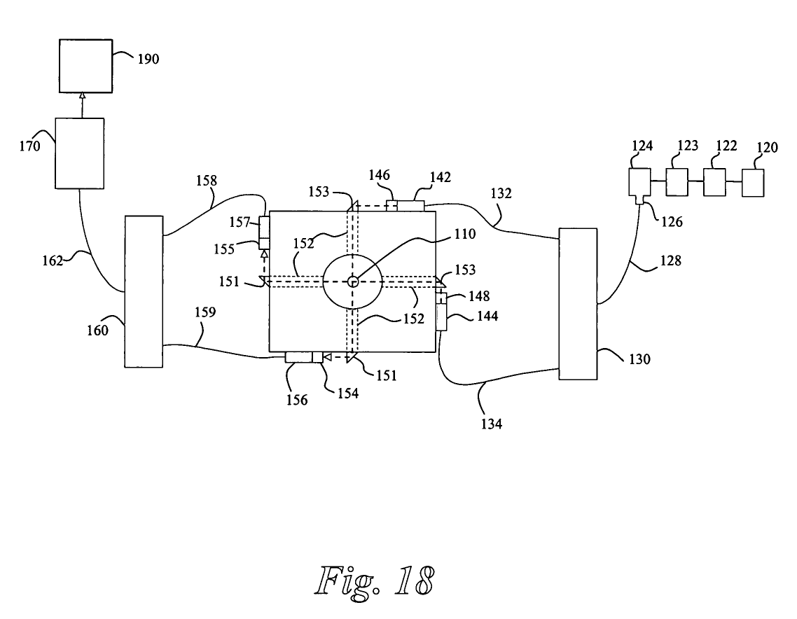

A block diagram of one embodiment of the present invention is illustrated in FIG. 18. A birefringent linkage material 110, such as a crystalline material, is sized to measure a user-defined set range of forces. A laser light source 120 emits coherent light that is optically coupled to a first collimator 122 which concentrates the laser beam into a narrow beam. A first linear polarizer 123 is an input polarizer. The polarizer 123 receives the collimated beam and limits it to a single polarization state. The polarized laser beam is then optically coupled to a polarization state modulator 124, which provides a periodic variation in the phase of the beam. A fiber optic coupler 126 optically couples the polarization state modulated laser light to an input side of a first polarization-maintaining (“PM”) optical fiber 128. An output side of the optical fiber 128 is optically coupled to a conventional beam splitter 130. Any conventional beam splitter known in the art may be used, including but not limited to fiber optic splitters, variable density beam splitters, polarizing cube beam splitters, stepped-density beam splitters, prisms, pellicle beam splitters, plate beam splitters, dielectric beam splitters and mirrored splitters. A fiber-optic splitter 130 is preferred. The fiber-optic splitter 130 splits the laser light into two modulated beams, which are optically coupled to the polymer birefringent linkage 110 by a second PM optical fiber 132 and third PM optical fiber 134. Any other conventional coupling means known in the art may also be used to optically couple the modulated beams to linkage 110, including but not limited to, mirrors. The polarization state modulated polarized light present at the output sides of the optical fibers 132, 134 is collimated by second and third collimators 142, 144 and polarized by second and third linear polarizers 146, 148. The light emitted by the polarizers 146, 148 is injected through the linkage material 110 generally orthogonally using a fourth set of polarization-maintaining optical fibers 152 and reflective prisms 153. The light beams, containing the stress information from physical force applied to the linkage 110, are optically coupled to a first and second linear analyzer 154, 155 by reflective prisms 151. The linear analyzers 154, 155 linearly polarize the light beams and then optically couple them to the first and second lenses 156, 157 to transmit light intensity information. The information-containing light beams are then transmitted by a first and second single-mode (“SM”) optical fiber 158, 159 to a SM fiber optic multiplexer 160. The multiplexed optical signals are then optically coupled to a high speed photodetector 170 via a third SM optical fiber 162. The optical signals are decoded and analyzed by the high-speed photodetector 170 and a signal recovery electronics processor 190 into an equivalent electrical signal.

The signal recovery processor 190 mathematically combines dc and harmonic signals (first harmonic or first and second harmonic) to obtain the optical phase retardance and molecular orientation angle in all three physical dimensions on the Cartesian coordinate system. The Stress-Optic rule, well-known in the art, is then applied to derive the individual stress tensors in three dimensions.

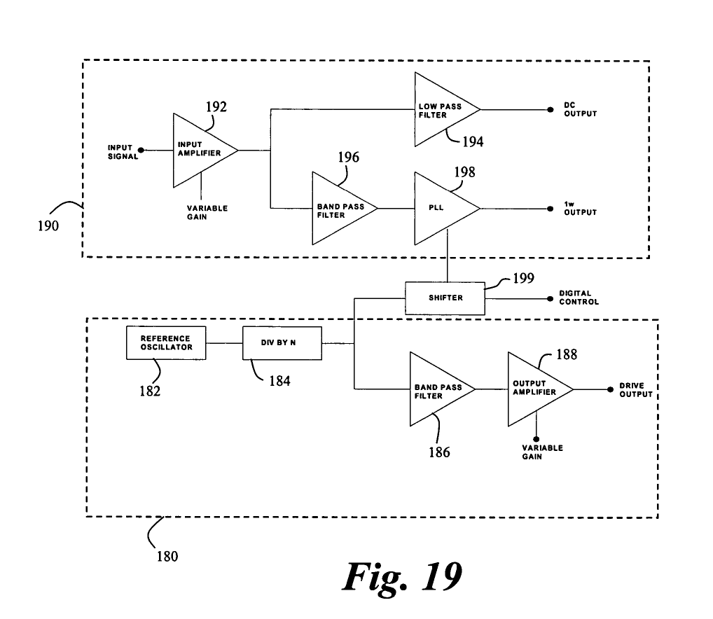

FIG. 19 depicts a block diagram of an example set of electronics for measuring the force transducer signals. A signal generator 180 for driving liquid crystal-based optical modulators, such as a 2 kilohertz signal, is generated by a reference oscillator 182. A divider 184 reduces the frequency of the drive signal. A bandpass filter 186 further shapes the drive signal by limiting the drive signal to a desired range of frequencies. An amplifier 188 having variable-gain capability provides the desired voltage and current characteristics for compatibility with the optical modulator (not shown). The drive signal is preferably an AC coupled sinusoidal electrical waveform. Measurement of the force is accomplished by a signal recovery processor 190 which measures both the DC component and modulation frequency of the source optical signal. An input amplifier 192 increases the amplitude of the source signal. The amplified source signal is then fed to a low pass filter 94 to provide a DC component of the source signal. A bandpass filter 196 and a phase locked loop (“PLL”) 198 are used to generate a modulation frequency component of the source signal that is referenced to the drive signal. A shifter 199 is used to provide digital control of the force-measuring electronics.

B. Open-Path Optical Force Measurement System

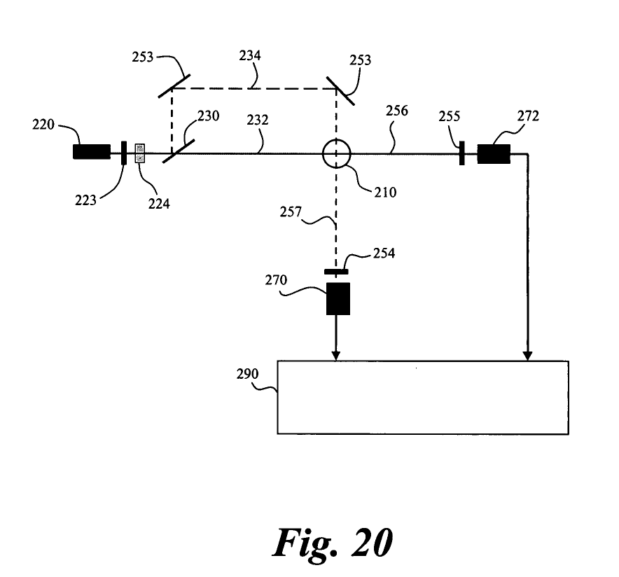

FIG. 20 illustrates an alternate embodiment of the present invention utilizing an open path optical design. A beam of light emitted by a laser 220 is optically coupled to a polarizer 223. The output of the polarizer 223 is optically coupled to a variable retarder 224. Any conventional variable retarder known in the art may be used, but a ferroelectric or nematic Liquid Crystal Variable Retarder (“LCVR”) is preferred. The LCVR's optical-orientation properties can be varied by the application of a voltage source. This effect is used to advantage to polarization state modulate the laser light beam. The light beam is split into two modulated beams by a fiber optic splitter 230. A first laser beam 232 is optically coupled to a birefringent polymer linkage 210 orthogonally to a second laser beam 234, which is optically coupled to the linkage 210 by mirrors 253. One skilled the art will recognize that any other conventional coupling means known in the art may also be used to optically couple the modulated beams to linkage 210, including but not limited to, fiber optic couplers. The output optical signals 256, 257, containing the stress information from physical force applied to the linkage 210, is optically coupled to a first and second linear analyzer 254, 255. The optical signals are decoded and analyzed using a first and second high-speed photodetector 270, 272 and signal recovery processor 290. The signal recovery processor shown in FIG. 20 may be used to obtain the optical phase retardance and molecular orientation angle in all three physical dimensions on the Cartesian coordinate system. The Stress-Optic rule is then applied to derive the individual stress tensors in three dimensions.

C. Comparison of Measurement Systems

The embodiment of FIG. 5 shows a configuration capable of only one-dimensional force or pressure measurements. The advantage of this configuration is lower cost and less complexity. The embodiments of FIGS. 16 and 20 show a modulated split light beam traversing the force transducer linkage at orthogonal angles. This configuration can measure all three stress tensors (1 normal and 2 shear or x, y and z).

5. Force Measurement

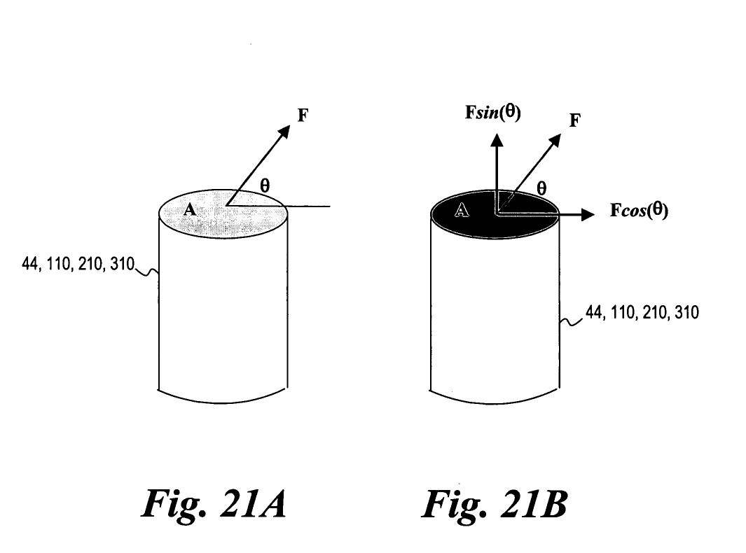

With reference to FIGS. 21A and 21B, the polymer linkage 44, 110, 210, 310 is characterized by a stress-optic coefficient in units of brewsters or m²/N. If a force, F acts on the linkage 44, 110, 210, 310 at an angle θ, then the shear stress T_{xy} is computed as the force parallel to the area, divided by the area (A). Mathematically, this relationship is given by equation 9:

$${τ}_{x y} = \frac{F cos ( θ )}{A} \qquad Equation 9$$

The shear stress is also computed as:

$${τ}_{x y} = \frac{1}{2 C} Δ {n}^{′} sin ( 2 χ ) . \qquad Equation 10$$

where C is the birefringent material's stress-optical coefficient, Δn′ is the material's birefringence and χ is the instantaneous orientation angle of the molecular polymer chains with respect to the flow direction. Setting equations 9 and 10 equal produces the following relationship relating the birefringence and molecular orientation angle to the directional force applied to the polymer linkage:

$$F cos ( θ ) = \frac{A}{2 C} Δ {n}^{′} sin ( 2 χ ) \qquad Equation 11$$

The present invention may be used to measure force, pressure and/or shear stress, preferably in terms of Newtons (kg*m/s²) or Pascals (kg/m*s²). Forces in a range from about 0.3 milligrams (0.00000294 Newtons) to 350 grams (3.43 Newtons) may be measured using a polystyrene linkage 44, 110, 210, 310 that is about 100 μm thick. Thicker linkages raise the useful measurement range while thinner linkages would lower this range. Force measurements may be obtained directly from a plot of optical phase retardance vs. applied load. Pressure or stress measurements may be obtained from equations 1 and 2.

6. Advantages of the Present Invention

The present invention provides a number of advantages over prior art force measurement systems, such as the mechanical systems previously discussed. For example, a force measurement system according to the present invention is able to measure small masses, such as a one-third milligram mass with 100 mm thick thin film polystyrene linkage. Other thinner linkages may be able to resolve even lower stresses. In addition, due to mathematical ratios inherent in the offset homodyne signal recovery techniques, the system performs with less than half of one percent measurement signal drift.

A further advantage of the present invention is that the force measurement system is able to resolve both positive and negative stresses. The sensitivity of the force measurement system depends on polymer linkage thickness, material composition, the amount of pre-stress applied to linkage material and environmental factors such as temperature.

A yet further advantage of the present invention is that the force measurement system is able to detect and measure fast transient loads, on the order of about 4.2 kHz using a 42 kHz polarization modulation frequency. The fast response allows measurement of forces that would otherwise not be detected.

It should be noted that there is a range where a linear relationship exists between applied force and optical phase retardance produced by the polymer linkage within the force transducer. This relationship determines the useful force measurement range for each polymer linkage that may be used. These ranges are different for different materials, different optical pathlengths (material thicknesses) and different geometric configurations. The relationship between the applied force and optical phase retardance produced by the polymer linkage within a particular force transducer becomes nonlinear toward the lower and upper force measurement capability ranges of the transducer. Force, pressure or stress measurements can also be computed in this nonlinear range, but with less precision toward the asymptotic boundaries.

7. Example Embodiments of the Present Invention

A. Measuring Foot Stresses

The present invention enables the measurement of small forces, including small transient forces present for only a short period of time. An example application where the present invention may be utilized to advantage is with stress sensor arrays used in connection with diabetic patients.

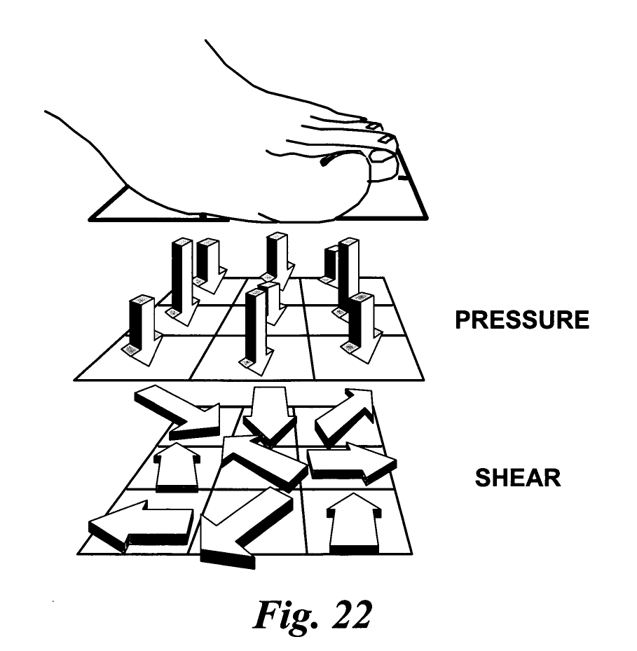

Diabetic patients frequently suffer from neuropathy. Diabetic neuropathy is a nerve disorder caused by diabetes. Symptoms of neuropathy include numbness and/or pain in the hands, feet, or legs. The damage to nerves often results in loss of reflexes and muscle weakness. The foot often becomes wider and shorter, the gait changes, and foot ulcers appear as pressure is put on parts of the foot that are less protected. Because of the loss of sensation, injuries may go unnoticed and often become infected. If ulcers or foot injuries are not treated in time, the infection may involve the bone and require amputation. Thus, there is a need for a sensor capable of monitoring the small, transient pressure and shear at various points of the sole of a diabetic patient's foot, in order to evaluate the effect of neuropathy on the patient and to take therapeutic steps directed at preventing foot injury and infection. FIG. 22 illustrates the typical forces present on the sole of a foot when pressure is exerted upon the foot by standing or walking.

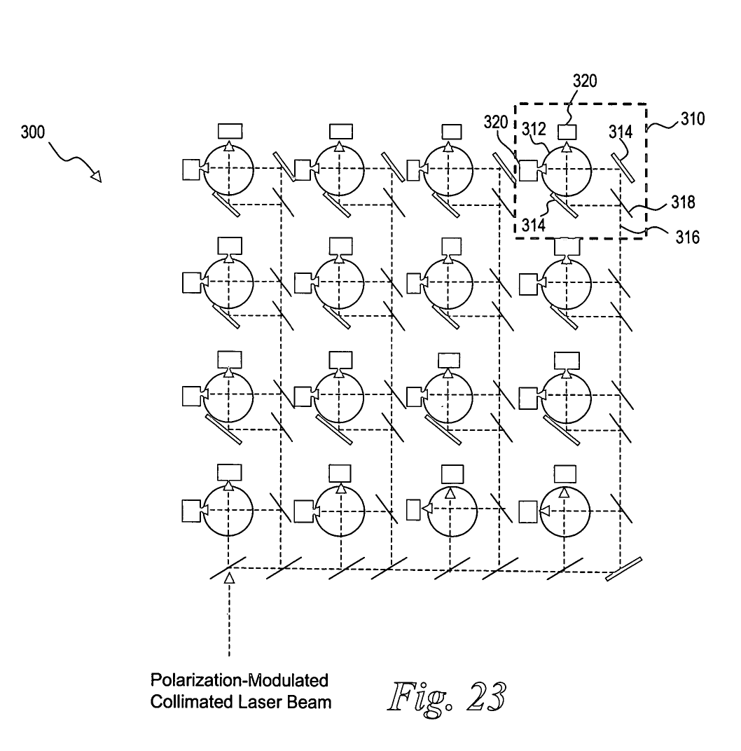

A foot stress sensor array 300 according to an embodiment of the present invention is shown in FIG. 23. In this example a 4×4 matrix of sensors 310 is used, though a greater or lesser number may be selected. Each birefringent transducer sensor 310 is comprised of a polymer transducer 312, mirrors 314 for lateral deflection of a polarization-modulated collimated laser beam 316, a beam splitter 318, and mirrors 320 to deflect light exiting transducer 312 downwardly to a receiver, such as an Si-PIN diode (not shown). Operation of each sensor 310 is in the manner previously described for open-path optical force measurement.

B. Other Embodiments

The present invention may be utilized to determine forces or stresses, plot force or stress as a function of time. Other uses include, but are not limited to, determining skin stress in diabetic foot patients, measuring transient blood pressure in each heartbeat, determining fast (such as about 10 kHz) transient stresses in rheometric or granular flow systems, and measuring small amounts of powders applied quickly in pharmaceutical drug manufacturing processes.

8. Diode Laser

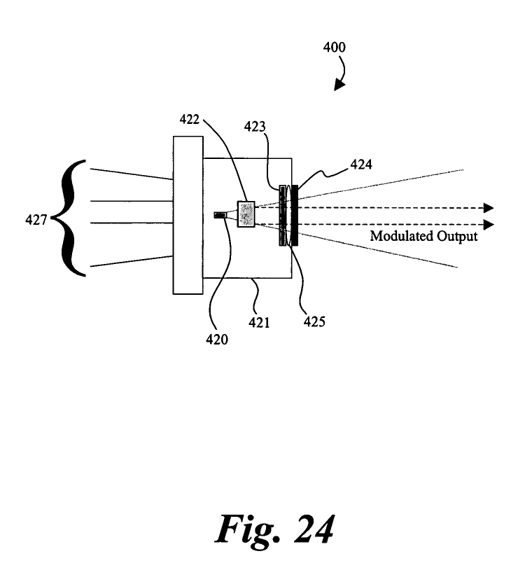

FIG. 24 illustrates an integrated polarization state modulated diode laser 400 that may serve as the input section of the force and pressure transducer. A lasing element 420 is affixed to a housing 421 such that light emitted by the lasing element is aimed toward a window 425. The light first passes through a collimating lens 422 which serves to concentrate the laser light into a narrow beam wherein the laser light waves are parallel. The light is optically coupled to a thin film polarizer 423, which limits the emitted light to a single polarization state. A polarization modulator 424 is used to vary, or modulate, the light emitted by the diode laser 400. A plurality of electrodes 427 are connected to the lasing element 420 and modulator 424 to facilitate application of power and control voltages.

The diode laser 400 may also serve as a stand-alone device for other non-force associated measurements. Example measurements may include rheology of complex fluids, such as molecular stress and orientation angle; optical material characterization (crystal birefringence); and biomedical/biological materials characterization of fluids, proteins and crystals.

9. Conclusion

While this invention has been shown and described with respect to a detailed embodiment thereof, it will be understood by those skilled in the art that various changes in form and detail thereof may be made without departing from the scope of the claims of the invention.

What is claimed is:

1. A birefringent linkage transducer for measuring force comprising a polymer having generally uniaxially oriented polymer chains.

2. A birefringent linkage transducer according to claim 1 wherein the polymer has been heated and stretched to further the uniaxial orientation of the polymer chains.

3. A birefringent linkage transducer according to claim 2 wherein the polymer is polystyrene.

4. A birefringent linkage transducer according to claim 1 wherein the polymer has been heated and compression molded to further the uniaxial orientation of the polymer chains.

5. A birefringent linkage transducer according to claim 4 wherein the polymer is polystyrene.

6. A system for measuring force applied to a transducer, comprising:
a) a source of coherent light having an output;
b) a linear polarizer optically coupled to the output of coherent light, effective to polarize the coherent light passing therethrough;
c) a variable retarder optically coupled to the polarized light;
d) a polarization state modulator optically coupled to the variable retarder to periodically vary the phase of the polarized light passing through the variable retarder;
e) a birefringent linkage transducer having generally uniaxially oriented polymer chains, the transducer being optically coupled to the phase-modulated, polarized light effective to generate a stress information optical signal when the phase-modulated, polarized light passes through the transducer;
f) a linear analyzer optically coupled to the optical signal to polarize the stress information optical signal;
g) a photodetector coupled to the polarized optical signal to derive stress tensors for the transducer, wherein the stress tensor data corresponds to the amount of force applied to the transducer.

7. A system according to claim 6 wherein the birefringent link transducer is polystyrene.

8. A system according to claim 6 wherein the variable retarder is a liquid crystal variable retarder.

9. A system according to claim 8 wherein the variable retarder is a ferroelectric liquid crystal variable retarder.

10. A system according to claim 8 wherein the variable retarder is a nematic liquid crystal variable retarder.

11. A system for measuring force applied to a transducer, comprising:
a) a source of coherent light having an output;
b) a first collimator optically coupled to the output, effective to concentrate the light into a beam of coherent light;
c) a first linear polarizer optically coupled to the beam of coherent light, effective to polarize the beam;
d) a polarization state modulator optically coupled to the first linear polarizer to periodically vary the phase of the beam of polarized, coherent light emitted from the first linear polarizer;
e) a beam splitter optically coupled to the polarization state modulator to split the phase modulated beam of light into first and second phase modulated sub-beams;
f) a second collimator optically coupled to the first phase modulated sub-beam;
g) a third collimator optically coupled to the second phase modulated sub-beam;
h) a birefringent linkage transducer having generally uniaxially oriented polymer chains, the transducer being optically coupled to the second and third collimators such that the first and second phase modulated sub-beams pass through the transducer generally orthogonally and intersect within the linkage, interaction at the intersection of the first and second sub-beams generating first and second stress information optical signals containing phase information from which the force applied to the linkage can be derived;
i) a first linear analyzer optically coupled to the first stress information optical signal to linearly polarize the first stress information optical signal;
j) a second linear analyzer optically coupled to the second stress information optical signal to linearly polarize the second stress information optical signal;
k) an optical multiplexer optically coupled to the first and second stress information optical signals to combine the first and second stress information optical signals into a multiplexed stress information optical signal;
l) a photodetector optically coupled to the optical multiplexer to decode the multiplexed optical stress information signal into a corresponding electrical signal; and
m) a signal recovery processor electrically coupled to the photodetector effective to derive phase retardance and molecular orientation angle and derive stress tensors for the transducer, the stress tensors corresponding to the amount of force applied to the transducer.

12. A system according to claim 11 wherein the beam splitter is a fiber optic splitter.

13. A system according to claim 11 wherein the birefringent link transducer is polystyrene.

14. A system according to claim 11 wherein the polarization state modulator is an electro-optic modulator.

15. A system according to claim 14 wherein the electro-optic modulator is a liquid crystal variable retarder.

16. A system according to claim 11 wherein the birefringent link transducer comprises an array of transducers arranged to measure force variations over a predetermined area.

17. A system for measuring force applied to a transducer, comprising:
a) a source of coherent light having an output;
b) a polarizer optically coupled to the output of coherent light to polarize the coherent light passing therethrough;
c) a variable retarder optically coupled to the polarizer to vary the optical orientation of the light;
d) a modulator electrically coupled to the variable retarder to modulate the light by periodically varying the orientation of the retarder with respect to the light;
e) a beam splitter to split the light into a first light sub-beam and a second light sub-beam;
f) a birefringent polymer linkage transducer having a generally uniaxially oriented polymer chains, the linkage being arranged such that the first light sub-beam and second light sub-beam are optically coupled to the linkage generally orthogonally and intersect within the linkage;
g) first and second optical signals output from the linkage transducer, the first and second optical signals resulting from interaction at the intersection of the first and second sub-beams within the linkage transducer, each optical signal containing phase information from which the force applied to the linkage can be derived;
h) a first linear analyzer optically coupled to the first optical signal to polarize the first optical signal;
i) a second linear analyzer optically coupled to the second optical signal to polarize the second optical signal;
j) a first photodetector optically coupled to the first linear analyzer to derive the force information from the first optical signal;
k) a second photodetector optically coupled to the second linear analyzer to derive the force information from the second optical signal; and
l) a recovery processor electrically coupled to the first and second photodetectors effective to derive optical phase retardance and molecular orientation information of the transducer in three dimensions, wherein individual stress tensors in three dimensions are derived from the optical phase retardance and molecular orientation information, the stress tensors relating to the force exerted upon the transducer.

18. A system according to claim 17, further comprising a collimator optically coupled to the source of coherent light to concentrate the light before coupling it to the polarizer.

19. A system according to claim 17 wherein the variable retarder is a liquid crystal variable retarder.

20. A system according to claim 17 wherein the beam splitter is a fiber optic light splitter.

21. A system according to claim 17 wherein at least one of the first and second light beams are optically coupled to the linkage by at least one mirror.

22. A system according to claim 17 wherein the birefringent link transducer is polystyrene.

23. A system according to claim 17 wherein the birefringent link transducer comprises an array of transducers arranged to measure force variations over a predetermined area.

24. A method for using a birefringent transducer for measuring applied force, comprising the steps of:
a) generating a beam of coherent light;
b) polarizing the beam of coherent light with a linear polarizer;
c) modulating the phase of the polarized beam of light with a variable retarder;
d) passing the modulated beam of light through a birefringent transducer, the birefringent transducer having generally uniaxially oriented polymer chains effective to generate a stress information optical signal;
e) passing the stress information optical signal through a linear analyzer to polarize the optical signal; and
f) deriving stress tensors for the transducer from the polarized optical signal, wherein the stress tensor data corresponds to the amount of force applied to the transducer.
